(19) United States
(12) Patent Application Publication
(10) Pub. No.: US 2023/0077557 A1
(43) Pub. Date: Mar. 16, 2023

(54) OPERATION DEVICE

(71) Applicant: KABUSHIKI KAISHA TOKAI RIKA DENKI SEISAKUSHO, Aichi (JP)

(72) Inventor: Takashi UENO, Aichi (JP)

(73) Assignee: KABUSHIKI KAISHA TOKAI RIKA DENKI SEISAKUSHO, Aichi (JP)

(21) Appl. No.: 17/891,472

(22) Filed: Aug. 19, 2022

(30) Foreign Application Priority Data
Sep. 10, 2021 (JP) 2021-148085

(51) Int. Cl. B62D 1/04; G06F 3/0354

(52) U.S. Cl. CPC B62D 1/046; G06F 3/03547

(57) ABSTRACT

There is provided an operation device comprising: a grip section configured to be held by a user; and at least one input section configured to receive input operation performed with an operation finger of the user who is holding the grip section, wherein the at least one input section is disposed in a designated range from the grip section on a basis of a range of motion of the operation finger in a state where the user is holding the grip section.

### CROSS REFERENCE TO RELATED APPLICATION(S)

This application is based upon and claims benefit of priority from Japanese Patent Application No. 2021-148085, filed on Sep. 10, 2021, the entire contents of which are incorporated herein by reference.

### BACKGROUND

The present invention relates to an operation device.

In recent years, operation devices that allow users to perform input operation while the user is holding the operation devices have been developed. For example, JP 2003-306149A discloses a steering wheel button device including a button section that is installed on a spoke and that is slidable while a user is holding a steering rim. Such a configuration makes it possible to slide the button to a position suitable to each user, and this makes it possible to improve operability.

### SUMMARY

However, the steering wheel button device according to JP 2003-306149A requires adjustment of the button position for each user, and this may cause the prior adjustment work to be cumbersome. Also, the steering wheel button device according to JP 2003-306149A requires to install a mechanism to slide the button, and this may increase manufacturing costs.

Accordingly, the present invention is made in view of the aforementioned issues, and an object of the present invention is to achieve a simpler configuration to improve operability related to input operation performed while the operation device is held.

To solve the above described problem, according to an aspect of the present invention, there is provided an operation device comprising: a grip section configured to be held by a user; and at least one input section configured to receive input operation performed with an operation finger of the user who is holding the grip section, wherein the at least one input section is disposed in a designated range from the grip section on a basis of a range of motion of the operation finger in a state where the user is holding the grip section.

As described above, according to the present invention, it is possible to achieve a simpler configuration to improve operability related to input operation performed while the grip section is held.

### BRIEF DESCRIPTION OF THE DRAWINGS

FIG. 1 is a block diagram illustrating a functional configuration example of an operation device 10 according to an embodiment of the present invention.

FIG. 2 is a diagram illustrating an example of arrangement of a grip section 110 and an input section 120 according to the embodiment.

FIG. 3 is a diagram for describing a designated range based on ranges of motion of an operation finger performing flexion and extension according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. EMBODIMENT

### 1.2. Functional Configuration Example

First, a functional configuration example of an operation device 10 according to an embodiment of the present invention will be described. The operation device 10 according to the present embodiment is a various kinds of devices configured to be operated while being held by a user.

Examples of the operation device 10 according to the present embodiment includes a steering wheel, a gear shifter, and the like that are installed in a mobile object such as a vehicle. However, the operation device 10 according to the present embodiment is not limited to the device installed in the mobile object. For example, the operation device 10 according to the present embodiment may be a device such as a smartphone or a tablet, in which a position to be held by the user is limited to a certain extent.

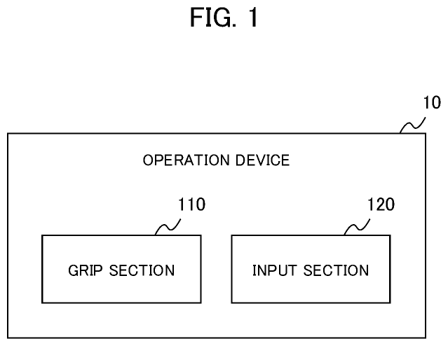

FIG. 1 is a block diagram illustrating a functional configuration example of the operation device 10 according to the embodiment of the present invention. As illustrated in FIG. 1, the operation device 10 according to the present embodiment includes at least a grip section 110 and an input section 120.

(Grip Section 110)

The grip section 110 according to the present embodiment is a structural element configured to be held by a user, or a region on the structural element.

For example, in the case where the operation device 10 according to the present embodiment is implemented as a steering wheel, the grip section 110 may be a region on a steering rim that is assumed to be held by the user.

Alternatively, in the case where the operation device 10 according to the present embodiment is implemented as a tablet, the grip section 110 may be a region on a casing that is assumed to be held by the user.

The grip section 110 according to the present embodiment may be configured on the basis of the shape, features, and the like of the operation device 10.

(Input Section 120) The input section 120 according to the present embodiment is a structural element configured to receive input operation performed with an operation finger (which is a finger that performs operation) of the user who is holding the grip section 110. The operation device 10 according to the present embodiment includes at least one input section 120.

One of features of the input section 120 according to the present embodiment is to be disposed in a designated range from the grip section 110 on the basis of a range of motion of the operation finger in a state where the user is holding the grip section 110.

For example, in the case where the operation finger is a thumb, the input section 120 according to the present embodiment may be disposed in a designated range from the grip section 110 on the basis of a range of motion of the thumb in a state where the user is holding the grip section 110.

Alternatively, in the case where the operation finger is an index finger, the input section 120 may be disposed in a designated range from the grip section 110 on the basis of a range of motion of the index finger.

Alternatively, in the case where both the thumb and the index finger serve as the operation fingers, an input section 120 corresponding to the thumb may be disposed in a designated range from the grip section 110 on the basis of the range of motion of the thumb, and an input section 120 corresponding to the index finger may be disposed in a designated range from the grip section 110 on the basis of the range of motion of the index finger.

The above-described arrangement of the input sections 120 makes it possible to achieve a simpler configuration to improve operability related to input operation performed while the grip section 110 is held.

In addition, the input section 120 according to the present embodiment may receive main input operation performed by the user on the grip section 110 in parallel with sub input operation performed with the operation finger.

For example, it is assumed that the operation device 10 according to the present embodiment is implemented as the steering wheel. In this case, the main input operation performed on the grip section 110 may be steering operation. In addition, the sub input operation may be control over a vehicle body, an air conditioner, audio equipment, or the like, which are performed in parallel with the steering operation.

The arrangement of the input sections 120 according to the present embodiment makes it possible to effectively improve operability related to various kinds of sub input operation performed in parallel with the main input operation.

The functional configuration example of the operation device 10 according to the present embodiment has been described above. Note that, the functional configuration described above with reference to FIG. 1 is a mere example. The functional configuration of the operation device 10 according to the present embodiment is not limited thereto. For example, the operation device 10 according to the present embodiment may further include a structural element other than the structural elements described above. The functional configuration of the operation device 10 according to the present embodiment can be flexibly modified in accordance with specifications and operations.

### 1.2. Example of Arrangement of Grip Section 110 and Input Section 120

Next, the arrangement of the grip section 110 and the input section 120 according to the present embodiment will be described with reference to a specific example.

As described above, one of features of the input section 120 according to the present embodiment is to be disposed in a designated range from the grip section 110 on the basis of a range of motion of the operation finger in a state where the user is holding the grip section 110.

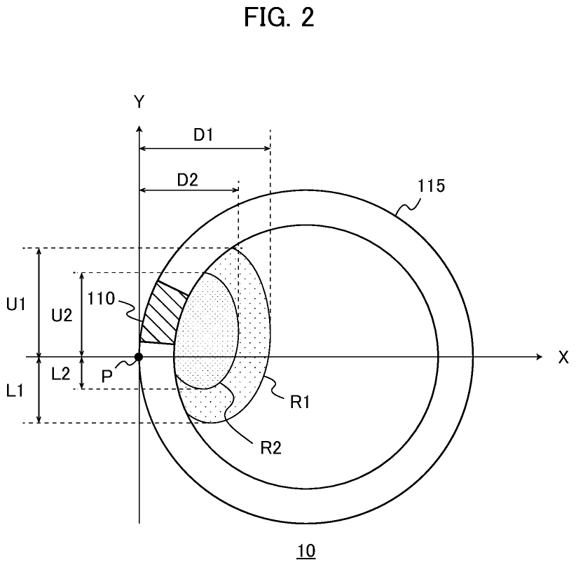

FIG. 2 is a diagram illustrating the example of arrangement of the grip section 110 and the input section 120 according to the present embodiment. Note that, FIG. 2 illustrates the example in which the operation device 10 according to the present embodiment is implemented as the steering wheel installed in the mobile object such as the vehicle.

In addition, in the case of the example illustrated in FIG. 2, the grip section 110 may be a region on a steering rim 115.

In this case, it is possible to define the designated range according to the present embodiment on the basis of evaluations by a plurality of examinees and physical features such as joints and the lengths of the operation fingers, for example.

As an example, the designated range according to the present embodiment may be defined on the basis of ranges of motion of the operation fingers performing adduction and abduction, and on the basis of subjective evaluations of burden on human bodies by the examinees.

Here, the adduction of operation fingers means motion of fingers of one hand in an approaching direction, and the abduction of operation fingers means motion of fingers of one hand in a separating direction.

For example, with regard to the ranges of motion of operation fingers performing adduction and abduction, the designated range according to the present embodiment may include an acceptable range R1 in which the input operation with the operation fingers is estimated to be allowed in a state where the grip section 110 is held.

As an example, the acceptable range R1 according to the present embodiment may be defined on the basis of ranges that are evaluated by a large number of examinees as capable of performing the input operation with the operation fingers (less burden on human bodies).

In addition, for example, the designated range according to the present embodiment may further include a recommended range R2 in which the input operation with the operation finger is estimated to be performed more easily than the acceptable range R1 in the state where the grip section 110 is held.

As an example, the recommended range R2 according to the present embodiment may be defined on the basis of ranges that are evaluated as capable of performing the input operation with the operation fingers, by a larger number of examinees than the number of examinees who has evaluated the acceptable range R1 as described above.

FIG. 2 illustrates an example of the acceptable range R1 and the recommended range R2 obtained in the case where the user holds the grip section 110 with his/her left hand.

Note that, in FIG. 2, an X-axis is defined as a direction from left to right when the steering rim 115 is viewed from the front, and a Y-axis is defined as a direction from bottom to top on a left end of the steering rim 115.

In this case, the acceptable range R1 may be defined by an upper limit U1 in a positive direction of the Y-axis, a lower limit L1 in a negative direction of the Y-axis, and a far limit D1 in a positive direction of the X-axis, on the basis of an intersection point P1 of the X-axis with the Y-axis.

In a similar way, the recommended range R2 may be defined by an upper limit U2 in the positive direction of the Y-axis, a lower limit L2 in the negative direction of the Y-axis, and a far limit D2 in the positive direction of the X-axis, on the basis of the intersection point P1 of the X-axis with the Y-axis.

The input section 120 of the operation device 10 according to the present embodiment is disposed in the acceptable range R1 or the recommended range R2, which are defined as described above. Such a configuration makes it possible to achieve a simpler configuration to improve operability related to the input operation performed while the grip section 110 is held.

Note that, in the case where the operation device 10 includes a plurality of the input sections 120, different functions may be allocated to an input section 120 disposed in the acceptable range R1 and an input section 120 disposed in the recommended range R2, depending on their features.

For example, a higher priority function may be allocated to the input section 120 disposed in the recommended range R2 in comparison with a function allocated to the input section 120 disposed in the acceptable range R1.

For example, in the case where the operation device 10 according to the present embodiment is implemented as the steering wheel, functions directly related to control over the mobile object may have higher priority. Therefore, for example, a function related to adaptive cruise control (ACC) may be allocated to the input section 120 disposed in the recommended range R2, and functions related to control over an air conditioner and audio equipment may be allocated to the input section 120 disposed in the acceptable range R1.

On the other hand, the priorities of the functions may be decided depending on frequency of input operation. In this case, a function having high frequency of the input operation may be allocated to the input section 120 disposed in the recommended range R2, and a function having low frequency of the input operation may be allocated to the input section 120 disposed in the acceptable range R1.

The example of arrangement of the input sections 120 based on the range of motion of operation fingers performing adduction and abduction has been described above with reference to FIG. 2. The above-described arrangement of the input sections 120 makes it possible to achieve a simpler configuration to improve operability related to input operation performed while the grip section 110 is held.

However, the designated range according to the present embodiment is not limited to the ranges of motion of the operation fingers performing adduction and abduction. The designated range according to the present embodiment may be defined on the basis of ranges of motion of an operation finger performing flexion and extension.

Here, the flexion of the operation finger means motion of the operation finger in a direction in which the operation finger bends at a joint, and the extension of the operation finger means motion of the operation finger in a direction in which the joint of the operation finger straightens.

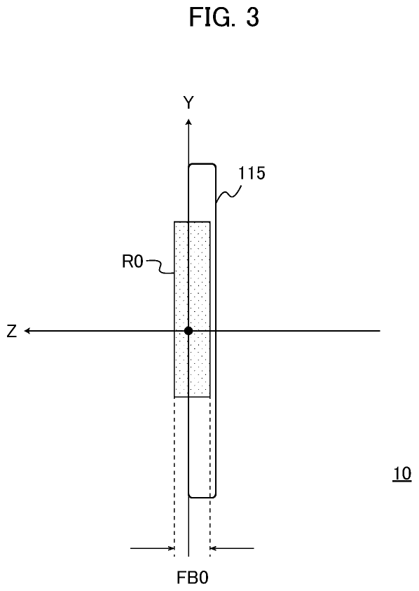

FIG. 3 is a diagram for describing a designated range based on ranges of motion of an operation finger performing flexion and extension according to the present embodiment.

FIG. 3 illustrates an example of a designated range R0 that is set on the basis of the ranges of motion of an operation finger performing flexion and extension when the steering rim 115 is viewed from its side. The designated range R0 may be defined on the basis of ranges that are evaluated by a large number of examinees as capable of performing the input operation with the operation finger (less burden on human bodies).

Note that, in FIG. 3, a Z-axis is defined as a direction from a back side to a front side of the steering rim 115, and a Y-axis is defined as a direction from bottom to top on a front end of the steering rim 115.

In this case, the designated range R0 may be defined by a front-back limit FB0 in positive and negative directions of the Z-axis on the basis of the Y-axis. Note that, the front-back limit FB0 may include a front limit and a back limit, which starts from the front end of the steering rim 115. The front limit extends in a front direction and the back limit extends in a depth direction when viewed from the user.

The input section 120 of the operation device 10 according to the present embodiment is disposed in the designated range R0, which is defined as described above. Such a configuration makes it possible to achieve a simpler configuration to improve operability related to input operation performed while the grip section 110 is held.

### 2. SUPPLEMENT

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. An operation device comprising:
a grip section configured to be held by a user; and
at least one input section configured to receive input operation performed with an operation finger of the user who is holding the grip section,
wherein the at least one input section is disposed in a designated range from the grip section on a basis of a range of motion of the operation finger in a state where the user is holding the grip section.

2. The operation device according to claim 1, wherein
the designated range includes an acceptable range in which the input operation with the operation finger is estimated to be allowed in a state where the grip section is held, and
the at least one input section is disposed in the acceptable range from the grip section.

3. The operation device according to claim 2, wherein
the designated range further includes a recommended range in which the input operation with the operation finger is estimated to be performed more easily than the acceptable range in the state where the grip section is held, and
the at least one input section is disposed in the recommended range from the grip section.

4. The operation device according to claim 3,
wherein a higher priority function is allocated to the input section disposed in the recommended range in comparison with a function allocated to the input section disposed in the acceptable range.

5. The operation device according to claim 1,
wherein the designated range is defined on a basis of ranges of motion of the operation finger performing adduction and abduction.

6. The operation device according to claim 1,
wherein the designated range is defined on a basis of ranges of motion of the operation finger performing flexion and extension.

7. The operation device according to claim 1,
wherein the input section receives main input operation performed by the user on the grip section in parallel with sub input operation performed with the operation finger.

8. The operation device according to claim 1,
wherein the operation device is installed in a mobile object.

9. The operation device according to claim 1,
wherein the operation device is a steering wheel.
